(19) United States
(12) Patent Application Publication
(10) Pub. No.: US 2024/0042897 A1
(43) Pub. Date: Feb. 8, 2024

(54) BATTERY PACK AND VEHICLE

(71) Applicant: HONDA MOTOR CO., LTD., Tokyo (JP)

(72) Inventors: Yaozhong Huo, Guangzhou (CN); Yang Li, Guangzhou (CN); Jianhua Yu, Guangzhou (CN); Jian Li, Guangzhou (CN)

(21) Appl. No.: 18/227,331

(22) Filed: Jul. 28, 2023

(30) Foreign Application Priority Data
Aug. 4, 2022 (CN) 202210931464.9

(51) Int. Cl. B60L 58/26; H01M 10/6568; H01M 10/613; H01M 10/625

(52) U.S. Cl. CPC B60L 58/26; H01M 10/6568; H01M 10/613; H01M 10/625

(57) ABSTRACT

A battery pack comprising housing and battery arranged on said housing, wherein heat-exchanger-flow-channel is provided for regulating the temperature of the battery, and said heat-exchanger-flow-channel comprises heat-exchanger-inlet, heat-exchanger-outlet, and at least one flow section connecting said heat-exchanger-inlet and said heat-exchanger-outlet; said heat-exchanger-inlet and said heat-exchanger-outlet are located higher than said flow section; said flow section is connected to said heat-exchanger-inlet through feeding chamber, and when the horizontal cross-sectional area of said feeding chamber at a position connected to said heat-exchanger-inlet is defined as A and the cross-sectional area of said heat-exchanger-inlet is defined as B, 0.5A≤B≤1.2A; and/or said flow section is connected to said heat-exchanger-outlet through a discharging chamber, and when the horizontal cross-sectional area of said discharging chamber at a position connected to said heat-exchanger-outlet is defined as C and the cross-sectional area of said heat-exchanger-outlet is defined as D, 0.5C≤D≤1.2C.

### CROSS-REFERENCE TO RELATED APPLICATION

Priority is claimed on Chinese Patent Application No. 202210931464.9, filed on Aug. 4, 2022, the contents of which are incorporated herein by reference.

### BACKGROUND OF THE INVENTION

### Field of the Invention

The present invention relates to a battery pack and a vehicle.

### Description of Related Art

The battery carried by an electric vehicle provides the electrical energy needed to run the electric vehicle. However, the performance of the battery is greatly affected by the temperature when providing electric power to the electric vehicle. If the temperature of the battery is too high, it may have an impact on the life of the battery and may even cause a safety incident. If the temperature of the battery is too low, the performance of the battery will be seriously affected, which in turn will affect the range of the electric vehicle.

In order to enable the battery to work within its appropriate temperature range, heat exchange pipes are usually placed around the battery, and the heat exchanger in the heat exchange pipes is used to exchange heat with the battery, thus realizing the regulation of the battery temperature. However, in order to obtain sufficient heat exchange power, it is usually necessary to inject a large amount of heat exchanger into the heat exchange pipes, which will increase the weight of the vehicle and affect the range of the electric vehicle. In addition, the flow rate of the heat exchanger in the heat exchange pipes is affected by the pressure loss, and the larger the pressure loss, the slower the flow rate of the heat exchanger, and the lower the heat transfer efficiency between the heat exchanger and the battery. Therefore, there is an urgent need for a vehicle battery pack and its housing to be able to achieve light weight, reduce the pressure loss of the heat exchanger and improve the heat transfer efficiency.

### SUMMARY OF THE INVENTION

In view of the above problems of the prior art, this application provides a battery pack and vehicle that can reduce weight, achieve light weight, reduce the pressure loss of a heat exchanger and improve the heat exchange efficiency.

The first aspect of the present application provides a battery pack comprising a housing and a battery provided in the housing, wherein a heat exchanger flow channel for regulating the temperature of the battery is provided on the housing, the heat exchanger flow channel comprises a heat exchanger inlet, a heat exchanger outlet, and at least one flow section connecting the heat exchanger inlet to the heat exchanger outlet, the heat exchanger inlet and the heat exchanger outlet are located higher than the flow section, the flow section is connected to the heat exchanger inlet through a feeding chamber, when the horizontal cross-sectional area of the feeding chamber connected to the heat exchanger inlet being defined as A and the horizontal cross-sectional area of the heat exchanger inlet being defined as B, 0.5A≤B≤1.2A; and/or the flow section is connected to the heat exchanger outlet through the discharging chamber, and when the horizontal cross-sectional area of the discharging chamber connected to the heat exchanger outlet is defined as C and the cross-sectional area of the heat exchanger outlet is defined as D, 0.5C≤D≤1.2C. Based on this, by setting the heat exchanger inlet and the heat exchanger outlet above the flow section, it is possible to prevent the heat exchanger inlet and the heat exchanger outlet and their connected pipes from colliding with objects below the housing, and reduce the chance of leakage due to collision. As a result, the protective structure for the heat exchanger inlet and the heat exchanger outlet can be reduced and the structural strength of the housing can be improved.

In addition, since the heat exchanger inlet and the heat exchanger outlet are located above the flow section, the heat exchanger flows in the feeding chamber and the discharging chamber in the up-down direction. As a result, the horizontal cross-sectional areas of the feeding chamber and the discharging chamber are the cross-sectional areas of the heat exchanger flowing in the feeding chamber and the discharging chamber. The cross-sectional areas of the heat exchanger inlet and the heat exchanger outlet are the cross-sectional areas of the heat exchanger flowing in the heat exchanger inlet and the heat exchanger outlet. By setting the cross-sectional area of the heat exchanger inlet to 0.5 times to 1.2 times the horizontal cross-sectional area of the feeding chamber, and by setting the cross-sectional area of the heat exchanger outlet to 0.5 times to 1.2 times the horizontal cross-sectional area of the discharging chamber, when the heat exchanger flows through the heat exchanger inlet, the heat exchanger outlet, the feeding chamber, and the discharging chamber, the space for the heat exchanger to pass through does not change too much, thus reducing the pressure loss of the heat exchanger, avoiding sudden changes in the flow rate of the heat exchanger, and improving the heat exchange efficiency. At the same time, it avoids an excessive size of the heat exchanger inlet or outlet, which will increase the amount of heat exchanger used, thus achieving light weight.

As a possible embodiment of the first aspect, the horizontal cross-sectional area A of the feeding chamber and the cross-sectional area B of the heat exchanger inlet are set to A=B; and/or the horizontal cross-sectional area C of the discharging chamber and the cross-sectional area D of the heat exchanger outlet are set to C=D.

Based on this, when the heat exchanger flows through the heat exchanger inlet, the heat exchanger outlet, the feeding chamber, and the discharging chamber, the space for the heat exchanger to pass through remains unchanged, further reducing the pressure loss of the heat exchanger and improving the heat exchange efficiency.

As a possible embodiment of the first aspect, the horizontal cross-sectional area of the feeding chamber is gradually increased from top to bottom, and/or the horizontal cross-sectional area of the discharging chamber is gradually decreased from bottom to top.

By setting the cross-sectional area of the feeding chamber in the horizontal direction to be gradually increased from top to bottom, the heat exchanger flowing in the feeding chamber is guided to flow in a diffuse manner in the feeding chamber to each branch. By setting the cross-sectional area of the discharging chamber in the horizontal direction to be gradually decreased from bottom to top, the heat exchanger flowing in the discharging chamber is guided to flow in the discharging chamber toward the heat exchanger outlet in a convergent manner, so that the heat exchanger is discharged from the heat exchanger outlet. As a result, the pressure loss of the heat exchanger in the feeding chamber and the discharging chamber can be reduced, facilitating the flowing of the heat exchanger, and improving the effect of temperature regulation.

As a possible embodiment of the first aspect, the heat exchanger flow channel comprises two flow sections; and the heat exchanger flow channel also comprises a flow chamber. The flow chamber has an inferiorly curved cross-sectional shape in the horizontal direction on the side away from the flow sections.

By providing the flow chamber with an inferiorly curved shape, the heat exchanger in the flow chamber can be guided, thereby reducing the pressure loss of the heat exchanger in the flow chamber. It is also possible to prevent some of the heat exchanger from being sludged in the flow chamber and thereby failing to participate in the regulation of the battery temperature, thus improving the efficiency of the temperature regulation of the heat exchanger. In addition, the flattened arc-shaped flow chamber can reduce the volume of the flow chamber compared with the semi-circular or pointed arc-shaped flow chamber, thus allowing for a more compact housing.

As a possible embodiment of the first aspect, the flow chamber has a trapezoidal cross-sectional shape in the horizontal direction, the lower bottom edge of the trapezoid is provided on the side close to the flow section, and the upper bottom edge of the trapezoid is located away from the flow section.

Since the length of the upper bottom edge of the trapezoid is smaller than the length of the lower bottom edge, by setting the cross-sectional shape of the flow chamber in the horizontal direction as a trapezoid, it is possible to make the coolant in the first flow section enter the flow chamber from the position of the lower bottom edge of the trapezoid near one side into the flow chamber, and the coolant can be guided by both sides of the trapezoid and the upper bottom edge, so that the coolant flows from the lower bottom edge of the trapezoid near the other side into the second flow section. As a result, the pressure loss of coolant in the flow chamber can be reduced and some of the heat exchanger can be prevented from being sludged in the flow chamber. At the same time, the trapezoidal structure can achieve the same effect of reducing the volume of the flow chamber and making the housing structure more compact compared to a cavity with a semi-circular structure or an arc-shaped structure.

As a possible embodiment of the first aspect, the two flow sections of the heat exchanger flow channel together form a U-shaped structure with the flow chamber.

Based on this, by setting the two flow sections of the heat exchanger flow channel and the flow chamber in a U-shape, the number of turns of the heat exchanger flowing in the heat exchanger flow channel can be reduced, and thus the pressure loss of the heat exchanger can be reduced and the effect of temperature regulation can be improved.

As a possible embodiment of the first aspect, the number of heat exchanger flow channels is two or more.

Based on this, the heat exchanger flow channels can be arranged more rationally to improve the effect of temperature regulation of the battery.

As a possible embodiment of the first aspect, the heat exchanger flow channels extend along the length of the housing.

Based on this, since the length dimension of the housing is larger than the width dimension, the heat exchanger flow channels extend in the length direction of the housing. The length of the heat exchanger flow channels at the turning position can be shortened compared with the heat exchanger flow channels extending along the width of the housing or in other directions. As a result, the length of the heat exchanger flow channels can be shortened, and the pressure loss of the heat exchanger can be reduced and light weight can be achieved. In addition, the extension of the heat exchanger flow channels along the length of the housing also reduces the number of heat exchanger flow channels that need to be laid out, thereby reducing the number of turns in the heat exchanger flow channels and reducing the pressure loss of the heat exchanger.

As a possible embodiment of the first aspect, the flow section comprises at least two branched paths, and the at least two branched paths are spaced apart and arranged in parallel.

Based on this, by making the branched paths spaced apart and arranged in parallel, it is possible to regulate the temperature of the battery more precisely at the location where the temperature needs to be regulated by each branched path. At the same time, it is possible to reduce the amount of heat exchanger in the heat exchanger flow channels by reducing the amount of heat exchanger in the locations where there is no need for temperature regulation, and thus the weight of the whole vehicle can be reduced.

As a possible embodiment of the first aspect, a mounting position is provided on the housing, and the mounting position is provided between two branched paths; the branched paths are provided with a deflecting bend, and the deflecting bend is in the shape of an arc to avoid the mounting position.

Based on this, when there is a mounting position provided between the branched paths, a deflecting bend can be provided on the branched paths so that the branched paths can avoid the mounting position. As a result, the influence between the branched paths and the mounting position can be reduced.

As a possible embodiment of the first aspect, the farther away from the mounting position a branched path is, the smaller the curvature of the deflecting bend on the branched path.

Based on this, by setting the curvature of the deflecting bend on the branched paths farther away from the mounting position to be smaller, it is possible to make the width of the deflecting bend of different branched paths more uniform, which in turn makes the pressure loss of the heat exchanger more uniform between different branched paths, in order to improve the temperature regulation effect. At the same time, it is also possible to reduce the variation of the widths of the branched paths in the deflecting bend, and thus reduce the pressure loss of the heat exchanger in the branched paths.

As a possible embodiment of the first aspect, the widths of the branched paths are the same.

Based on this, by setting the widths between the branched paths to be the same, the pressure loss of the heat exchanger in the different branched paths is made more uniform to avoid the pressure loss increase of the heat exchanger in the heat exchanger flow channels caused by too much pressure loss in one branched path. At the same time, by setting the widths between the branched paths to be the same, the flow rate of the heat exchanger in each branched path can also be made more uniform, which leads to a more uniform rate of regulation of the battery temperature and improves the temperature regulation effect.

As a possible embodiment of the first aspect, when the height of the branched paths is defined as h, 2.1 mm≤h≤3.1 mm.

Based on this, a preferred range of the height of the branched paths is provided so that it is possible to reduce the weight of the heat exchanger in the heat exchanger flow channels while reducing the pressure loss of the heat exchanger in the heat exchanger flow channels and obtaining a good cooling coefficient.

As a possible embodiment of the first aspect, the housing comprises: a lower housing and a base plate, the base plate is mounted on the lower housing, and heat exchanger flow channels are formed between the base plate and the lower housing.

By forming heat exchanger flow channels between the base plate and the lower housing, it is possible to eliminate the need for separately arranging cooling tubes and other components for the heat exchanger flow. As a result, the structure of the housing can be simplified, the weight of the housing can be reduced, and light weight can be achieved. It is also possible to reduce the number of parts of the housing, reduce assembly steps and assembly time, and improve assembly efficiency.

As a possible embodiment of the first aspect, the battery comprises at least two battery modules, and each battery module comprises at least two battery cells; the base plate is provided with at least two raised bumps toward the lower housing; and each bump corresponds to the position of one battery cell.

Based on this, the structural strength of the base plate can be improved by providing the bumps on the base plate. As a result, the thickness and weight of the base plate can be reduced while meeting the strength requirements of the base plate, and thus the weight of the housing can be reduced to achieve light weight. In addition, when a milling cutter is required to machine one side surface of the base plate towards the electric core, only the upper surfaces of the bumps need to be machined, thereby reducing the workload of milling cutters and increasing the processing speed.

As a possible embodiment of the first aspect, the lower housing is connected to the battery by a heat transfer adhesive.

Based on this, the heat transfer adhesive can be provided between the lower housing and the battery, thereby improving the heat transfer effect between the lower housing and the battery, and thus improving the effect of temperature regulation.

As a possible embodiment of the first aspect, it further comprises: a heat insulation layer provided on a side of the base plate away from the lower housing.

Based on this, by providing the heat insulation layer on the base plate, it is possible to reduce the effect of the ambient temperature on the housing and the battery inside the housing.

A third aspect of the present application provides a vehicle comprising a vehicle body, and a battery pack provided on the vehicle body, said battery pack is any one of the possible embodiments of the battery pack described in the first aspect of the present application.

Based on this, the battery pack in the first aspect is installed on the vehicle, and it is possible to reduce the chance of leakage of fluid due to collision by setting the heat exchanger inlet and the heat exchanger outlet above the flow section, so that collision of the heat exchanger inlet and the heat exchanger outlet and the pipes connected thereto and other parts with objects appearing below the housing can be avoided. As a result, the protective structures for the heat exchanger inlet and the heat exchanger outlet can be reduced and the structural strength of the housing can be improved.

In addition, since the heat exchanger inlet and the heat exchanger outlet are located above the flow section, the heat exchanger flows up and down in the feeding chamber and the discharging chamber. As a result, the horizontal cross-sectional areas of the feeding chamber and the discharging chamber are the cross-sectional areas of the heat exchanger flowing in the feeding chamber and the discharging chamber. The cross-sectional areas of the heat exchanger inlet and the heat exchanger outlet are the cross-sectional areas of the heat exchanger flowing in the heat exchanger inlet and the heat exchanger outlet. By setting the vertical cross-sectional area of the heat exchanger inlet to 0.5 times to 1.2 times the horizontal cross-sectional area of the feeding chamber and the cross-sectional area of the heat exchanger outlet to 0.5 times to 1.2 times the horizontal cross-sectional area of the discharging chamber, when the heat exchanger flows through the heat exchanger inlet, the heat exchanger outlet, the feeding chamber and the discharging chamber, the space for the heat exchanger to pass through does not change too much, thus reducing the pressure loss of the heat exchanger, avoiding sudden changes in the flow rate of the heat exchanger, and improving the heat exchange efficiency. At the same time, the size of the heat exchanger inlet or the heat exchanger outlet is prevented from being too large, which will increase the amount of heat exchanger, thus achieving light weight.

As a possible embodiment of the third aspect, said first flow section and said second flow section extend along the length of said vehicle in the length direction.

Based on this, for example, when the length direction of the battery cells in the battery pack is consistent with the length direction of the vehicle, the extension direction of the first and second flow sections can be the same as the length direction of the battery cells. Since the length dimension of the battery cells is larger than the width dimension, when the first and second flow sections extend in the length direction of the vehicle under the same contact area with the battery cells, compared to when they extend in the width direction of the vehicle, when the first and second flow sections extend in the length direction of the vehicle, the length and width of the first and second flow sections at the turning position are smaller. As a result, the capacity of the heat exchanger in the turning position of the first and second flow sections can be reduced, and thus the weight of the battery pack and the vehicle can be reduced and light weight can be achieved.

These and other aspects of the present invention will be more concisely understood from the description of the following (plural) embodiments.

### BRIEF DESCRIPTION OF THE DRAWINGS

The various features of the present invention and the connection between the various features are further described below with reference to the accompanying drawings. The accompanying drawings are exemplary, some features are not shown to actual scale, and some of the accompanying drawings may omit features that are customary in the field covered by this application and are not essential to this application, or additionally show features that are not essential to this application. The combination of features shown is not intended to limit the present application. In addition, throughout this specification, the same appended markings are the same. The specific accompanying drawings are illustrated as follows:

FIG. 1 is a schematic diagram of a use case of a housing of a battery pack of a vehicle in an embodiment of the present application;

FIG. 2 is a schematic diagram of the structure of the battery pack in the embodiment of the present application;

FIG. 3 is a schematic diagram of the structure of the housing in FIG. 2;

FIG. 4 is a schematic diagram of the side structure of the housing in FIG. 3;

FIG. 5 is a schematic diagram used to illustrate the shape of heat exchanger flow channels;

FIG. 6 is a schematic diagram of a comparison between the flow chamber of the embodiment of the present application and flow chambers with other shapes;

FIG. 7 is a schematic diagram of the structure of the battery module in FIG. 2;

FIG. 8 shows a comparative diagram of the heat exchanger flow channels extending in the length and width directions of the battery cells;

FIG. 9 shows a comparative schematic diagram of the flow direction of the heat exchanger;

FIG. 10 shows the qualified lines for the heat transfer coefficient (effect), pressure loss, and weight of the heat exchanger;

FIG. 11 is a partial cross-sectional diagram of the housing in the embodiment of the present application at the locations of the heat exchanger inlet and the heat exchanger outlet in a vertical plane;

FIG. 12 is a schematic diagram of the three-dimensional structure of the battery pack in one embodiment of the present application;

FIG. 13 shows the schematic diagram of the structure of the housing in FIG. 12;

FIG. 14 is an exploded schematic diagram of the housing in FIG. 12;

FIG. 15 is a schematic diagram of the structure of the lower housing in FIG. 14;

FIG. 16 is a schematic diagram of the structure of the base plate in FIG. 14;

FIG. 17 is a radial cross-sectional diagram of the heat exchanger inlet and the heat exchanger outlet in FIG. 13;

FIG. 18 shows a locally enlarged schematic diagram of the feeding chamber and the discharging chamber in FIG. 13; and

FIG. 19 is a partial cross-sectional enlarged view of the battery pack in the corresponding position of the battery cells in FIG. 12.

### BRIEF DESCRIPTION OF THE REFERENCE SYMBOLS

1 vehicle; 10 battery pack; 20 vehicle body; 30 wheel; 100 housing; 110 heat exchanger flow channel; 111 heat exchanger inlet; 112 heat exchanger outlet; 113 first flow section; 114 second flow section; 115 branched path; 115a concave part; 116 feeding chamber; 117 discharging chamber; 118 flow chamber; 119 deflecting bend; 120 first mounting position; 130 lower housing; 131 convex bar; 132 mounting portion; 140 base plate; 141 bump; 142 second mounting position; 200 battery; 210 battery module; 211 battery cell.

### DETAILED DESCRIPTION OF THE INVENTION

The terms “first, second, third, etc.” or module A, module B, module C, and similar terms in the specification and claims are used only to distinguish similar objects and do not represent a specific ordering of objects, and it is understood that specific orders or sequences may be interchanged where permitted so that embodiments of the present application described herein can be implemented in an order other than that illustrated or described herein.

The term “comprises” as used in the specification and claims should not be construed as limiting to what is listed thereafter, and it does not exclude other components or steps. Accordingly, it should be interpreted as designating the presence of said feature, whole, step, or component mentioned, but does not preclude the presence or addition of one or more other features, whole, steps, or components and groups thereof. Thus, the expression “apparatus comprising parts A and B” should not be limited to an apparatus comprising only parts A and B.

References in this specification to “an embodiment” or “embodiments” mean that the particular feature, structure or characteristic described in conjunction with that embodiment is included in at least one embodiment of the present invention. Thus, the terms “in one embodiment” or “in an embodiment” appearing throughout this specification do not necessarily refer to the same embodiment, but may refer to the same embodiment. In addition, in one or more embodiments, the particular features, structures, or characteristics can be combined in any suitable manner, as would be apparent from the present disclosure to one of ordinary skill in the art.

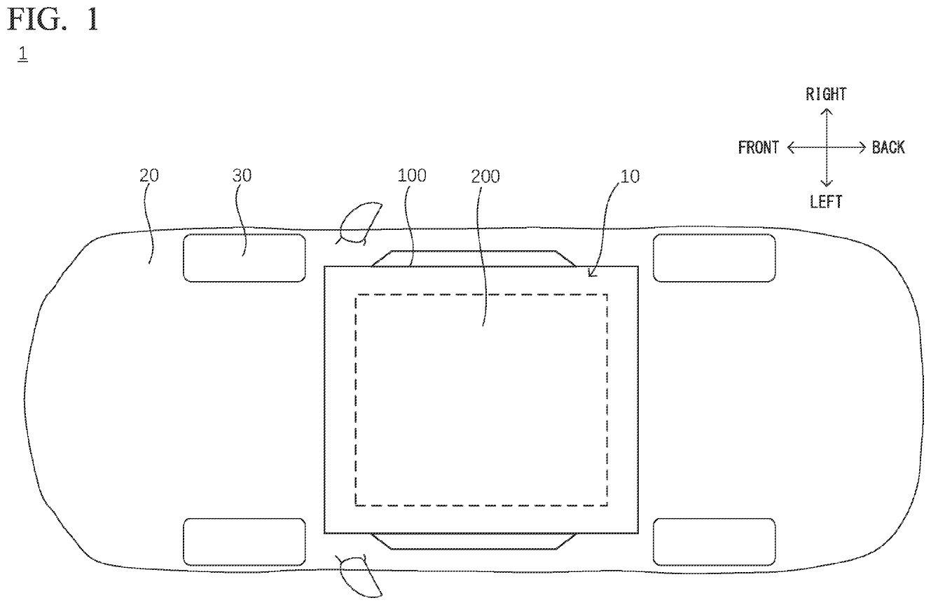

FIG. 1 is a schematic diagram of a use case of a housing 100 of a battery pack 10 of a vehicle 1 in this application embodiment. FIG. 1 and the vehicle 1 herein are illustrated exemplarily as an electric vehicle and should not be considered as a limitation of this application. The vehicle 1 can be an electric vehicle or a hybrid vehicle, and can be any of different types of vehicles such as cars, trucks, passenger buses, (sport utility vehicles (SUVs), etc. The vehicle 1 can also be a tricycle, a two-wheeled vehicle, a train, or another land transportation device that carries people or goods.

As shown in FIG. 1, the vehicle 1 in this application embodiment comprises a vehicle body 20, wheels 30, a battery pack 10, and other devices. The wheels 30 are provided at the bottom of the vehicle body 20, and the wheels 30 rotate so that the vehicle 1 can be moved. The battery pack 10 is provided on the vehicle body 20, specifically, in the middle of the bottom of the vehicle body 20, or in any other suitable location. The battery pack 10 includes a housing 100 and a battery 200, which is mounted on the housing 100 to provide the electrical energy required by the vehicle 1.

The specific structure of the battery pack 10 in this application embodiment will be described in detail below, in combination with the accompanying drawings.

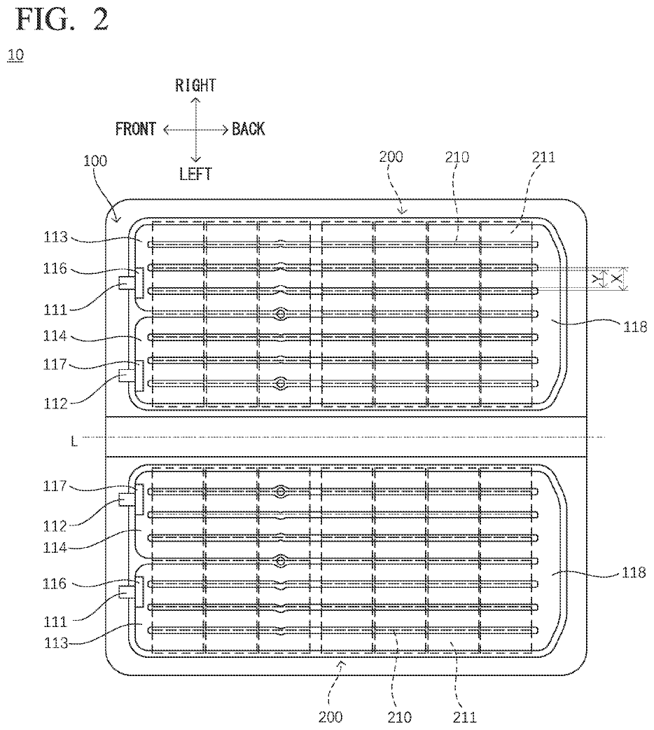

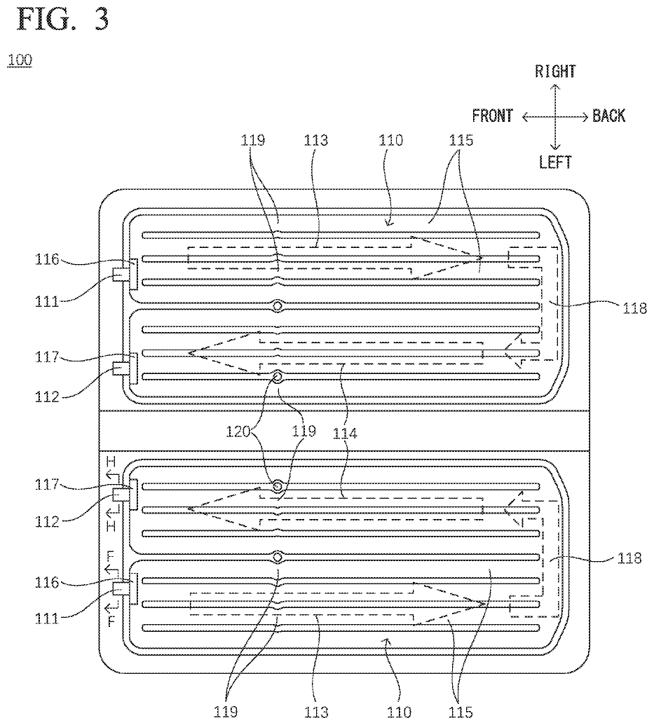

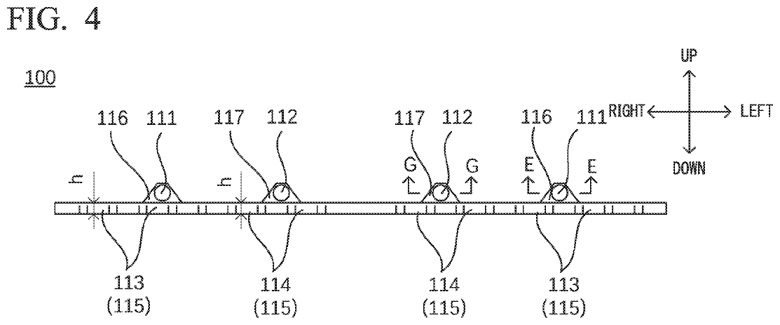

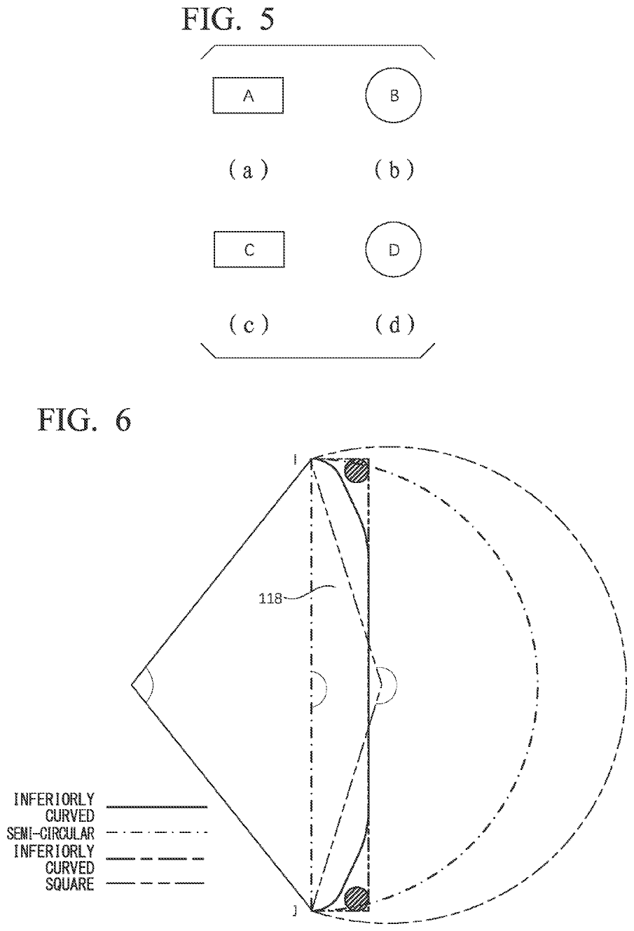

FIG. 2 is a schematic diagram of the structure of the battery pack 10 in this application embodiment; FIG. 3 is a schematic diagram of the structure of the housing 100 in FIG. 2; FIG. 4 is a schematic diagram of the side structure of the housing in FIGS. 3; and FIG. 5 is a schematic diagram for illustrating the shape of the heat exchanger flow channels, wherein (a) in FIG. 5 is a cross-sectional schematic diagram of the feeding chamber 116 in the E-E direction in FIG. 4, (b) in FIG. 5 is a cross-sectional schematic diagram of the heat exchanger inlet 111 in the F-F direction in FIG. 3, (c) in FIG. 5 is a cross-sectional schematic diagram of the discharging chamber 117 in the G-G direction in FIG. 4, and (d) in FIG. 5 is a cross-sectional schematic diagram of the heat exchanger outlet 112 in the H-H direction in FIG. 3.

As shown in FIGS. 2 to 4, the battery pack 10 in this application embodiment comprises a housing 100 and a battery 200 provided on the housing 100, wherein the housing 100 is provided with a heat exchanger flow channel 110 for regulating the temperature of the battery 200, and the heat exchanger flow channel 110 includes a heat exchanger inlet 111, a heat exchanger outlet 112, and at least one flow section 113 or 114. The heat exchanger inlet 111 and the heat exchanger outlet 112 are located higher than the flow sections 113 and 114, the flow sections 113 and 114 are connected to the heat exchanger inlet 111 through the feeding chamber 116, and the flow sections 113 and 114 are connected to the heat exchanger outlet 112 through the discharging chamber 117. Thus, it is possible to avoid the collision of the heat exchanger inlet 111 and the heat exchanger outlet 112 and their connected pipes with objects appearing below the housing 100 and reduce the chance of liquid leakage due to collision. As a result, it is not necessary to set up a protective structure for the heat exchanger inlet 111 and the heat exchanger outlet 112, thus simplifying the structure of the housing 100 and reducing the weight of the housing 100.

(a) in FIG. 5 shows a horizontal cross section at the connection position between the feeding chamber 116 and the heat exchanger inlet 111, defining its area as A. (b) in FIG. 5 illustrates a cross section of the heat exchanger inlet 111, defining its area as B. Therein, the connection position between the feeding chamber 116 and the heat exchanger inlet 111, specifically, may be the center of a vertical cross section of the heat exchanger inlet 111. The cross section of the heat exchanger inlet 111 is specifically the cross section perpendicular to the direction of heat exchanger flowing in the heat exchanger inlet 111. The relationship between A and B may be 0.5A≤B≤1.2A.

(c) in FIG. 5 illustrates a horizontal cross section at the connection position between the discharging chamber 117 and the heat exchanger outlet 112, defining its area as C. (d) in FIG. 5 illustrates a cross section of the heat exchanger outlet 112, defining its area as D. The relationship between C and D may be 0.5C≤D≤1.2C.

Specifically, as shown in FIGS. 3 and 5, the cross sections of the heat exchanger inlet 111 and the heat exchanger outlet 112 are vertical cross sections perpendicular to the orientation of the heat exchanger inlet 111 and the heat exchanger outlet 112. Alternatively, when the heat exchanger inlet 111 and the heat exchanger outlet 112 are, for example, cylindrical, the cross sections of the heat exchanger inlet 111 and the heat exchanger outlet 112 are cross sections perpendicular to the axial direction of the heat exchanger inlet 111 and the heat exchanger outlet 112.

Since the heat exchanger inlet 111 and the heat exchanger outlet 112 are located above the flow section, the heat exchanger flows in the feeding chamber 116 and the discharging chamber 117 in the up-down direction. As a result, the horizontal cross-sectional areas of the feeding chamber 116 and discharging chamber 117 are the cross-sectional areas of the heat exchanger flowing in the feeding chamber 116 and the discharging chamber 117. The vertical cross-sectional areas of the heat exchanger inlet 111 and the heat exchanger outlet 112 are the cross-sectional areas of the heat exchanger flowing in the feeding chamber 116 and the discharging chamber 117.

If the relationship between A and B is B<0.5A, the size of the heat exchanger inlet 111 will be too small, and when delivering the heat exchanger from the heat exchanger inlet 111 to the feeding chamber 116, the flow rate of the heat exchanger needs to be increased in order to be able to meet the flow demand As a result, the performance requirements of the pump that drives the flow of the heat exchanger will be increased, making the selection of the pump more difficult and increasing the production cost of the vehicle.

If the relationship between C and D is D<0.5C, it will make the size of the heat exchanger outlet 112 too small, and the pressure loss of the heat exchanger will be too large when the heat exchanger flows from the discharging chamber 117 to the heat exchanger outlet 112, which thereby will affect the heat transfer efficiency.

If the relationship between A and B is B>1.2A, the size of the feeding chamber 116 will be too small, and when the heat exchanger flows from heat exchanger inlet 111 into the feeding chamber 116, it is possible to make a pressure loss of the heat exchanger too large, which thereby affects the heat exchange efficiency.

If the relationship between C and D is D>1.2C, it is possible to make a size of the heat exchanger outlet 112 too large and also increase the size of the pipes connected to the heat exchanger outlet 112, thus increasing the amount of heat exchanger that can be accommodated in the heat exchanger outlet 112 and the pipes connected to it, reducing the use efficiency of the heat exchanger, increasing the weight and energy consumption of the vehicle, and affecting the range of the vehicle.

By setting the cross-sectional area of the heat exchanger inlet 111 to 0.5 times to 1.2 times the horizontal cross-sectional area of the feeding chamber 116 and the cross-sectional area of the heat exchanger outlet 112 to 0.5 times to 1.2 times the horizontal cross-sectional area of the discharging chamber 117, when the heat exchanger flows through the heat exchanger inlet 111, the heat exchanger outlet 112, the feeding chamber 116, and the discharging chamber 117, the space for the heat exchanger to pass through will not undergo a significant change, thereby reducing the pressure loss of the heat exchanger, avoiding sudden changes in the flow rate of the heat exchanger, and improving the heat exchange efficiency.

In some embodiments, the horizontal cross-sectional area A of the feeding chamber 116 and the cross-sectional area B of the heat exchanger inlet 111 can be set as A=B; and/or the horizontal cross-sectional area C of the discharging chamber 117 and the cross-sectional area D of the heat exchanger outlet 112 can be set as C=D. Thus, when the heat exchanger flows through the heat exchanger inlet 111, the heat exchanger outlet 112, the feeding chamber 116, and the discharging chamber 117, the space for the heat exchanger to pass through remains the same, thus further reducing the pressure loss of the heat exchanger and improving the heat exchange efficiency.

As shown in FIG. 4, the feeding chamber 116 in this application has a trapezoidal shape when viewed from the side, and the cross-sectional area of the feeding chamber 116 in the horizontal direction gradually increases from top to bottom. Thus, the heat exchanger flowing in the feeding chamber 116 can be guided so that the heat exchanger flows in the feeding chamber 116 to each branched path 115 in a diffuse manner. As a result, the pressure loss of the heat exchanger in the feeding chamber 116 can be reduced, and the flow of the heat exchanger can be facilitated to improve the effect of temperature regulation.

As shown in FIG. 4, the discharging chamber 117 in this application has a trapezoidal shape when viewed from the side, and the cross-sectional area of the discharging chamber 117 in the horizontal direction is decreased from bottom to top. Thus, the heat exchanger flowing in the discharging chamber 117 can be guided to gradually converge as it flows towards the heat exchanger outlet 112 in the discharging chamber 117, so that the heat exchanger can be discharged from the heat exchanger outlet 112. Thus, the pressure loss of the heat exchanger in the feeding chamber 116 is reduced, the flow of the heat exchanger is facilitated, and the effect of temperature regulation is improved.

As shown in FIGS. 2 and 3, the heat exchanger flow channel 110 in the embodiment of the present application comprises two flow sections 113 and 114. Specifically, the heat exchanger flow channel 110 comprises a first flow section 113 and a second flow section 114, with one end of the first flow section 113 connected to the feeding chamber 116 and one end of the second flow section 114 connected to the discharging chamber 117.

As shown in FIG. 3, the heat exchanger flow channel 110 in this application embodiment also comprises a flow chamber 118 connected to the ends of two flow sections 113 and 114. Specifically, the flow chamber 118 is connected to the other ends of the first flow section 113 and the second flow section 114. Thus, the heat exchanger in the plurality of branched paths 115 of the first flow section 113 can converge in the flow chamber 118 and be delivered by the flow chamber 118 to the plurality of branched paths 115 of the second flow section 114, thereby reducing the pressure loss due to the transportation of the heat exchanger by dividing into at least two branched paths 115 from the first flow section 113 into the second flow section 114, and thereby improving the temperature regulation.

As shown in FIG. 3, the flow chamber 118 in this application has a curved shape when viewed from above. Specifically, the cross-sectional shape of the flow chamber 118 in the horizontal direction is curved. Thus, by providing the flow chamber 118 with an arc shape, the heat exchanger in the flow chamber 118 can be guided, thereby reducing the pressure loss of the heat exchanger in the flow chamber 118.

FIG. 6 is a schematic diagram of the flow chamber 118 in this application embodiment compared with other shapes of the flow chamber 118. As shown in FIG. 3 and FIG. 6, the flow chamber 118 in this application embodiment can be specifically provided with an inferiorly curved shape (i.e., as shown in FIG. 6, the corresponding central angle of the arc with I and J as endpoints is less than)180° . Compared with the semi-circular flow chamber 118 and the flow chamber 118 of an arc shape (i.e., as shown in FIG. 6, the corresponding central angle of the arc with I and J as endpoints is greater than 180°), the flow chamber 118 of the inferiorly curved shape occupies less space. As shown in FIG. 6, when the flow chamber 118 is square, the heat exchanger will be sludged in the shaded position in FIG. 6, and the heat exchanger in the shaded position will not participate in the temperature regulation of the battery cells 200. As a result, the heat exchanger will be wasted and the temperature regulation efficiency of the heat exchanger will be reduced.

Thus, by setting the flow chamber 118 in an inferiorly curved shape, the volume of the flow chamber 118 can be reduced, which can make the structure of the housing 100 more compact. It can also prevent some of the heat exchanger from being sludged in the flow chamber 118, and thus being unable to participate in the regulation of the temperature of the battery cells 200, thus improving the temperature regulation efficiency of the heat exchanger.

As shown in FIGS. 3 and 6, the cross-sectional shape of the flow chamber 118 in the horizontal direction is trapezoidal, and the lower bottom edge of the trapezoid (i.e., the edge of the side of the flow chamber 118 connected to the first flow section 113 and the second flow section 114) is set close to the first flow section 113 and the second flow section 114. The upper top edge of the trapezoid (i.e., the edge away from the side of the flow chamber 118 connected to the first flow section 113 and the second flow section 114) is set far away from the first flow section 113 and the second flow section 114. Since the length of the upper top edge of the trapezoid is smaller than the length of the lower bottom edge, the flow chamber 118 is set in a trapezoid shape so that the coolant in the first flow section 113 can be guided by both sides of the trapezoid and the upper top edge after entering the flow chamber 118 from a position near one side of the lower bottom edge of the trapezoid. The coolant flows from a position near the other side of the lower bottom edge of the trapezoid to the second flow section 114. As a result, the pressure loss of coolant in the flow chamber 118 can be reduced, and some of the heat exchanger can be prevented from being sludged in the flow chamber 118. At the same time, the trapezoidal structure can also reduce the volume of the flow chamber 118 compared to the semi-circular or arc- shaped chamber, resulting in a more compact structure of the housing 100.

As shown in FIG. 3, the two flow sections 113 and 114 of the heat exchanger flow channel 110 and the flow chamber 118 in this application are in a U-shape, i.e., the first flow section 113 and the second flow section 114 are connected to the flow chamber 118 to form a U-shape structure together. As a result, the number of turns of the heat exchanger flowing in the heat exchanger flow channel 110 can be reduced compared with that of an S-shaped flow channel, and thus the pressure loss of the heat exchanger can be reduced and the temperature regulation effect can be improved.

As shown in FIG. 3, the number of heat exchanger flow channels 110 is two or more. Specifically, the heat exchanger inlet 111 is farther from the center of the battery 200 than the heat exchanger outlet 112, and the first flow section 113 is farther from the center of the battery 200 than the second flow section 114. The center of the battery 200 may be on a centerline L extending in a front-back direction as shown, for example, in FIG. 3. Alternatively, in other embodiments, when the battery 200 is rectangular, for example, the center of the battery 200 can also be the intersection of the diagonal lines of the battery 200.

Thus, by setting the heat exchanger inlet 111 farther away from the center of the battery 200 than the heat exchanger outlet 112, and by setting the first flow section 113 farther away from the center of the battery 200 than the second flow section 114, after entering the first flow section 113 from the heat exchanger inlet 111, the heat exchanger can first exchange heat with the outer part of battery 200 that is greatly affected by environmental temperature; and after the heat exchanger flows into the second flow section 114, the heat exchanger then exchanges heat with the middle part of the battery 200, which is less affected by the environmental temperature. As a result, the temperature difference between the different positions of the battery 200 can be reduced and the temperature regulation effect can be improved.

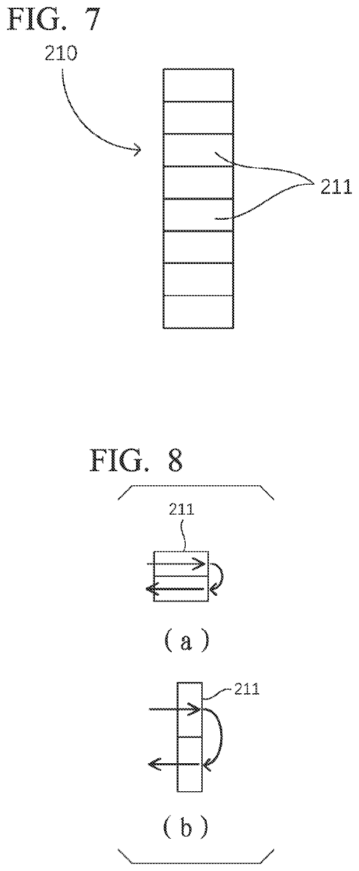

FIG. 7 shows the structure of the battery module 210 in FIG. 2. As shown in FIG. 2 and FIG. 7, the battery 200 comprises at least two battery modules 210, and the battery modules 210 each comprise at least two battery cells 211. Specifically, as shown in FIGS. 2 and 7, at least two battery cells 211 are arranged side by side in the width direction of the battery cells 211 to form a battery module 210, with the length direction of the battery cells 211 being the same as the length direction of the housing 100.

Since the space available for the battery pack 10 on the vehicle 1 is limited, the arrangement of the battery modules 210 in the housing 100 is limited. For this reason, as shown in FIG. 2, the present application provides a preferred arrangement of the battery modules 210, i.e., after the installation of battery modules 210, the length direction of battery cells 211 is consistent with the front-back direction of the vehicle 1. Compared to the arrangement of other battery modules 210, for example, when the battery modules 210 are installed, the length of the battery cells 211 is aligned with the left-right direction of the vehicle 1, or when the battery modules 210 are installed, the length direction of the battery cells 211 of some battery modules 210 is aligned with the front-back direction of vehicle 1, and the length direction of the battery cells 211 of some battery modules 210 is aligned with the left-right direction of vehicle 1. The maximum number of battery modules 210 can be reached according to the arrangement of battery modules 210 in FIG. 7.

As shown in FIGS. 2 and 3, the heat exchanger flow channel 110 in this application embodiment extends in the length direction of the housing 100.

FIG. 8 shows a comparison of the extension of the heat exchanger flow channel 110 in the length direction and the width direction of the battery cells 211. In FIG. 8, (a) shows the extension of the heat exchanger flow channel 110 in the length direction of the battery cells 211, and (b) shows the extension of the heat exchanger flow channel 110 in the width direction of the battery cells 211. As shown in FIG. 8, since the length dimension of the battery cells 211 is larger than the width dimension, according to the width/length correspondence of the branched paths 115 and the battery cells 211, the first flow section 113, the second flow section 114 and their branch paths 115 extend in the length direction of the battery cells 211 according to (a) in FIG. 8, reducing the width of the first flow section 113, the second flow section 114 and the branched paths 115 thereof. It is also possible to reduce the length required for the turns of the first flow section 113 and the second flow section 114, i.e., the length of the flow chamber 118. Thereby, the flow amount of the heat exchanger can be reduced and the weight of the battery can be reduced. In addition, the first flow section 113, the second flow section 114, and their branched paths 115 extend in the width direction of the battery cells 211 as shown in (b) in FIG. 8, compared to (a) in FIG. 8, in which the extend in the length direction of the battery cells 211, the heat exchanger flow channel 110 requires a greater curvature in the bend and a greater bend distance when turning. If the turning arc of the heat exchanger flow channel 110 in (b) of FIG. 8 decreases, the pressure loss of the heat exchanger flowing in the first flow section 113 and the second flow section 114 increases. Therefore, extending the heat exchanger channel 110 in the length direction of the battery cells 211 can shorten the length of the heat exchanger channel 110, reduce the pressure loss of the heat exchanger, and achieve light weight.

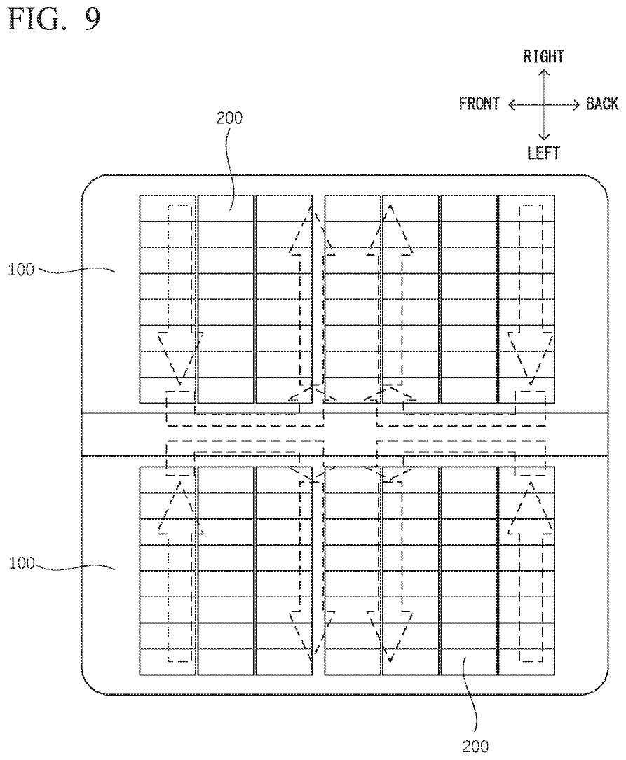

FIG. 9 shows a comparative example of the flow direction of the heat exchanger, and the arrows in FIG. 9 illustrate the flow direction of the heat exchanger when the first flow section 113 and the second flow section 114 extend in the width direction of the battery cells 211. By comparing FIG. 9 with FIG. 3, it can be seen that when the first flow section 113 and the second flow section 114 are arranged in accordance with the length direction of the battery cells 211, the number of turns in the first flow section 113 and the second flow section 114 is smaller than the number of turns in the first flow section 113 and the second flow section 114 arranged in the width direction of the battery cells 211. As a result, the length of the heat exchanger flow channel 110 and the number of turns can be reduced, thereby reducing the pressure loss of the heat exchanger and improving the temperature regulation effect.

As shown in FIG. 3, the flow sections 113 and 114 include at least two branched paths 115 spaced apart and arranged in parallel, specifically, the first flow section 113 and the second flow section 114 may each include at least two branched paths 115 spaced apart and arranged in parallel, as shown in FIG. 3. Thus, the arrangement positions of the branched paths 115 can correspond to the arrangement of the battery cells 211, so as to more accurately regulate the temperature of the battery cells 211 of the battery 200. In addition, by providing at least two branched paths 115 in the first flow section 113 and the second flow section 114, the amount of the heat exchanger that can be accommodated in the first flow section 113 and the second flow section 114 can be reduced. Specifically, for example, as will be described in the following embodiment, the first flow section 113 and the second flow section 114 are divided into at least two branched paths 115 by providing convex bars 131 in the first flow section 113 and the second flow section 114, thereby reducing the amount of the heat exchanger that can be accommodated in the first flow section 113 and the second flow section 114. At the same time, due to the fact that the width of the branched paths 115 does not need to be equal to the width of the battery cells 211, there may be a gap between adjacent battery cells 211, and therefore the convex bars 131 are provided in the first flow section 113 and the second flow section 114, and can reduce the inflow of the heat exchanger and reduce the weight of the battery pack while meeting the heat exchange effect.

As shown in FIG. 3, the widths of the branched paths 115 in the first flow section 113 and/or the second flow section 114 are the same. As a result, it is possible to make the pressure loss of the heat exchanger more uniform between the different branched paths 115 and avoid increasing the pressure loss of the heat exchanger in the heat exchanger channel 110 due to excessive pressure loss of a certain branched path 115. At the same time, by setting the widths of the branched paths 115 to be the same, the flow rate of the heat exchanger in each branched path 115 can be made more uniform, and thereby the temperature of the battery 200 can be regulated at a more uniform rate and the temperature regulation effect can be improved.

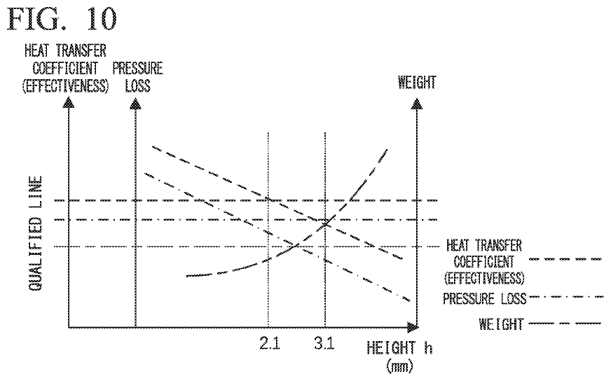

FIG. 10 is a schematic diagram of the heat transfer coefficient, pressure loss, and weight of the heat exchanger in the branched paths 115 in FIG. 3 as a function of the height of the branched paths 115. As shown in FIG. 4 and FIG. 10, in some embodiments, the height of the branched paths 115 can be defined as h, and the heat transfer coefficient (effectiveness), pressure loss, and weight of the heat exchanger in the branched paths 115 will change as the height h of the branched paths 115 increases, while the flow rate of the heat exchanger in the branched paths 115 remains constant.

Specifically, as the height h of the branched paths 115 increases, the volume of the heat exchanger in the branched paths 115 increases. Accordingly, the weight of the heat exchanger contained in the branched paths 115 increases.

As the height h of the branched paths 115 increases, the cross-sectional dimension of the branched paths 115 perpendicular to the heat exchanger flow direction increases. Since the flow rate of the heat exchanger remains the same, the flow rate of the heat exchanger is reduced. Since the faster the flow rate of the heat exchanger, the faster the heat exchange between the heat exchanger and the battery cells 200, i.e., the greater the heat transfer coefficient of the heat exchanger is, the better the heat exchange effect will be. Therefore, as the height h of the branched paths 115 increases, the heat exchange coefficient with the heat exchanger in the branched paths 115 decreases.

As the height h of the branched paths 115 increases, it makes the cross-sectional size of the branched paths 115 perpendicular to the heat exchanger flow direction increase. As a result, the heat exchanger can flow more easily in the branched paths 115, and thus the pressure loss of the heat exchanger in the branched paths 115 is reduced.

Qualified lines of the heat transfer coefficient (effectiveness), pressure loss, and weight of the heat exchanger are also shown in FIG. 10. As shown in FIG. 10, according to the qualified lines of the heat exchange coefficient (effectiveness), pressure loss, and weight of the heat exchanger, combined with the influence of height h on the heat exchange coefficient (effectiveness), pressure loss, and weight of the heat exchanger, it can be concluded that: when the height h of branched paths 115 is less than 2.1 mm, although the heat exchange coefficient of the heat exchanger is large and the heat exchange effect is good, the pressure loss of the heat exchanger is large, and the requirements for the water pump that drives the flow of the heat exchanger are too high, which will increase the difficulty of selecting the water pump and increase the production cost of the vehicle. When the height of branched paths 115 is greater than 3.1 mm, although it can reduce the pressure loss of the heat exchanger, it can also cause excessive weight of the heat exchanger, increase the energy consumption of the vehicle, and affect the vehicle's endurance. At the same time, it will also cause a heat exchange coefficient of the heat exchanger to be too small, resulting in poor heat exchange efficiency. Therefore, it is preferable to set the height h of branched paths 115 to 2.1 mm≤h≤3.1 mm Therefore, it is possible to reduce the weight of the heat exchanger in the branched paths 115, while reducing the pressure loss of the heat exchanger in the branched paths 115 and achieve a good heat transfer coefficient.

As shown in FIG. 3, the housing 100 in this application is provided with a first mounting position 120, the first mounting position 120 can be a mounting hole, a positioning hole, a positioning post or another structure, and the first mounting position 120 is provided between two branched paths 115. Specifically, the first mounting position 120 can be provided in a plurality as shown in FIG. 3, the plurality of first mounting positions 120 can be laid out in the width direction of the housing 100, and the first mounting positions 120 can be provided between only some of the branched paths according to the needs of the structure. The branched paths 115 is provided with a deflecting bend 119, and the deflecting bend 119 is bent to the left or right to avoid the first mounting position 120.

Thus, when the first mounting position 120 is between the branched paths 115, the first mounting position 120 can be avoided by providing the deflecting bend 119 on the branched paths 115. As a result, the influence between the branched paths 115 and the first mounting position 120 can be reduced.

As shown in FIG. 3, the farther a branched path 115 is from the first mounting position 120, the smaller the curvature of the deflecting bend 119 on the branched path 115 will be.

As a result, the width of the branched paths 115 at the deflecting bend 119 is approximately the same as the width at the other parts, and thereby the flow rate of the heat exchanger in the branched paths 115 is uniform and the temperature regulation effect is uniform. Further, it makes the pressure loss of the heat exchanger more uniform between different branched paths 115 to improve the temperature regulation effect.

As shown in FIG. 2, the branched paths 115 correspond to the battery cells 211 set side by side, and the width direction of the branched paths 115 is the same as the width direction of the battery cells 211. By defining the width of the battery cells 211 as X and the width of the branched paths 115 as Y, preferably, the relationship between X and Y can be set to 0.5X≤Y<X.

Based on this, by setting the width of the branched paths 115 to be greater than or equal to half of the width of the battery cells 211, it is possible to obtain sufficient contact area between the branched paths 115 and the battery cells 211, and at the same time it is possible to ensure that there is sufficient heat exchanger in the branched paths 115 so that heat exchange with the battery cells 211 can be achieved quickly. As a result, the heat exchanger flow channel 110 can be made to meet the heat exchange power demand of the battery 200. In addition, by setting the width of the branched paths 115 to be less than the width of the battery cells 211, the width of the branched paths 115 can be prevented from being too large and exceeding the width of the battery cells 211, making some heat exchangers in the branched paths 115 unable to participate in the heat exchange of the battery cells 211. Thus, it is possible to avoid excess weight and to avoid wasting the heat exchange power of the heat exchanger flow channel 110, and to achieve light weight.

More preferably, the width X of the battery cells 211 and the width Y of the branched paths 115 can also be set to 0.5X≤Y≤0.6X. Thus, the battery 200 can be further made lightweight while obtaining sufficient heat exchange power.

Since the space available for the battery pack 10 in the vehicle 1 is limited, the battery module 210 on the housing 100 is limited in its arrangement. For this reason, as shown in FIG. 2, the present application provides a preferred arrangement of battery modules 210 in which the length direction of the battery cells 211 after battery modules 210 are installed is in line with the front-back direction of vehicle 1. Compared with other arrangement of the battery modules 210, for example, if the length direction of the battery cells 211 is consistent with the left-right direction of vehicle 1 after the installation of the battery modules 210, or if the length direction of some battery cells 211 of the battery modules 210 is consistent with the front-back direction of the vehicle 1 and the length direction of some battery cells 211 of battery modules 210 is consistent with the left-right direction of the vehicle 1 after the installation of the battery modules 210, the maximum number of battery modules 210 can be reached according to the arrangement of the battery modules 210 in FIG. 2.

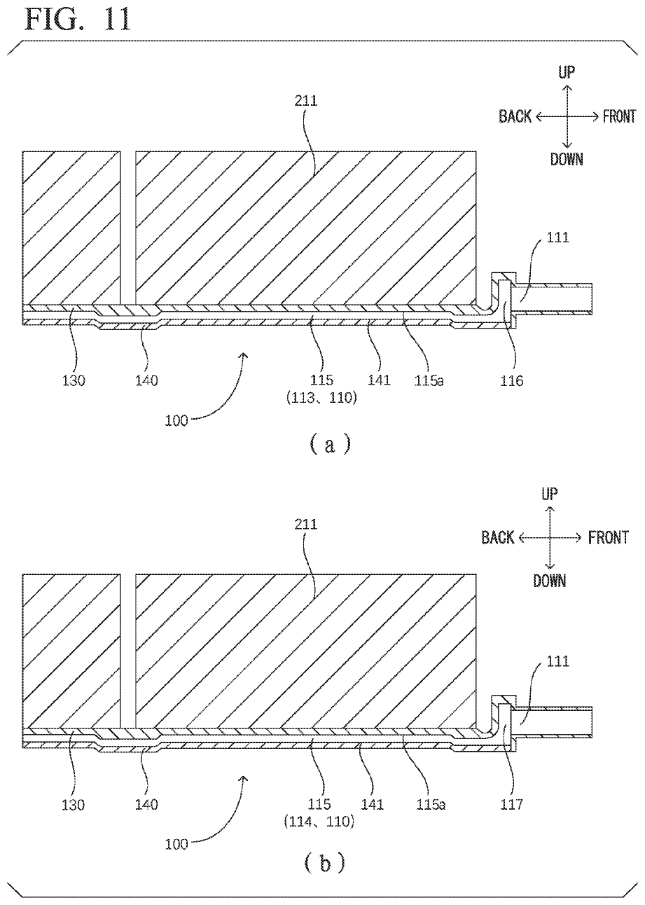

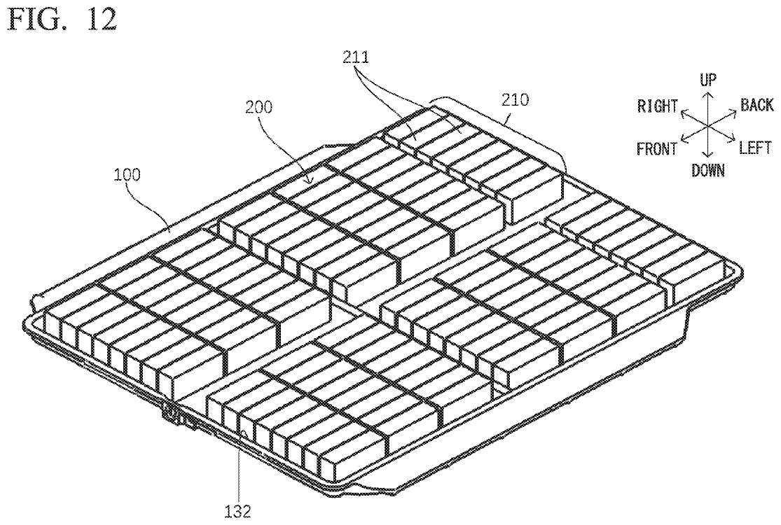

FIG. 11 is a partial cross-sectional diagram of the housing 100 in the embodiment of the present application in a vertical plane at the positions of the heat exchanger inlet 111 and the heat exchanger outlet 112. In FIG. 11, (a) shows the partial cross-sectional structure of the housing 100 in the position of the heat exchanger inlet 111 and (b) shows the partial cross-sectional structure of the housing 100 in the position of the heat exchanger outlet 112. As shown in FIG. 11, the housing 100 comprises a lower housing 130 and a base plate 140, which is mounted on the lower housing 130, and a heat exchanger flow channel 110 is formed between the base plate 140 and the lower housing 130, thereby eliminating the need for separately providing heat exchanger tubes and other components for the heat exchanger flow. Thus, the structure of the housing 100 can be simplified, and the weight of the housing 100 can be reduced to achieve light weight. At the same time, it is possible to reduce the number of parts of the housing 100, reduce assembly steps and assembly time, and improve the efficiency of assembly.

As shown in FIG. 11, the base plate 140 is provided with raised bumps 141, and the bumps 141 are provided on one side of the base plate 140 toward the lower housing 130, and are located at positions opposite to the battery cells 211. Specifically, the bumps 141 may be made of sheet metal, so that the bumps 141 are raised on the upper surface of the base plate 140 and concave on the lower surface of the base plate 140. The bumps 141 may be rectangular in shape to correspond to the shapes of the battery cells 211, with the upper surfaces of the bumps 141 having surface areas approximately equal to those of the battery cells 121. As a result, the structural strength of the base plate 140 provided with the bumps 141 is greater than that of the base plate with the same thickness in the form of a flat plate, and the strength of the base plate 140 at the corresponding positions of the battery cells 211 can be improved. In addition, in order to meet the strength requirement of the base plate 140, providing the bumps 141 on the base plate 140 can reduce the thickness and weight of the base plate 140 compared with increasing the thickness of the base plate 140, and thus can reduce the weight of the housing 100 and achieve light weight.

In addition, when the upper surface of the base plate 140 needs to be machined using a milling cutter, only the upper surfaces of the bumps 141 need to be machined, i.e., only the position corresponding to the battery cells 211 needs to be machined, thereby reducing the workload of milling cutter and increasing the machining speed.

As shown in FIG. 11, concave parts 115a are also provided on the side of the lower housing 130 near the base plate 140 that is recessed in the direction away from the base plate 140. The concave parts 115a are rectangular in shape and are located at corresponding positions above the bumps 141, forming concave shapes upwards. Thus, it is possible to make the thickness of the housing 130 at the corresponding positions of the battery cells smaller than the thickness of the other positions of the housing 130, thereby improving the heat exchange efficiency between the battery cells and the heat exchanger in the branched paths 115. In addition, by providing the concave parts 115a, the height of the branched paths 115 can be kept constant while the branched paths 115 fluctuate up and down, avoiding the influence of the bumps 141 on the height of the branched paths 115 and increasing the pressure loss. At the same time, as shown in FIG. 11, the up and down fluctuation of the branched paths 115 is smaller, which can reduce the pressure loss of the heat exchanger in the branched paths 115 caused by the up and down fluctuation of the branched paths 115, thus ensuring the heat transfer efficiency of the heat exchanger.

In some embodiments, the lower housing 130 and the battery 200 may also be connected to each other by a heat transfer adhesive. As a result, it is possible to improve the heat transfer effect between the lower housing 130 and the battery 200, thereby increasing the effectiveness of temperature regulation.

In some embodiments, the housing 100 may also comprise a heat insulation layer (not shown), which is provided on the side of the base plate 140 away from the lower housing 130. Thus, it is possible to reduce the effect of environmental temperature on the housing 100 and the battery 200 within the housing 100.

As shown in FIGS. 1 to 11, the above battery pack 10 can be provided on the vehicle body 20 of the vehicle 1, with the first flow section 113, the second flow section 114 and the branched paths 115 in the battery pack 10 extending along the length of the vehicle 1.

Based on this, when the length direction of the battery cells 211 in the battery pack 10 is consistent with the length direction of vehicle 1, for example, the extension direction of the first flow section 113 and the second flow section 114 can be the same as the length direction of the battery cells 211. Since the length dimension of the battery cells 211 is larger than the width, under the same contact area with the battery cells 211, the first flow section 113 and the second flow section 114 extend in the length direction of the vehicle 1. Compared with when they extend in the width direction of vehicle 1, when the first flow section 113 and the second flow section 114 extend in the length direction of vehicle 1, the length and width of the first flow section 113 and the second flow section 114 at the turning position are smaller. As a result, it is possible to reduce the capacity of the heat exchanger in the turning position of the first flow section 113 and the second flow section 114, thereby reducing the weight of the battery pack 10 and the vehicle 1 and achieving light weight.

The above content, combined with FIGS. 2 to 11, describes possible embodiments of a battery pack for a vehicle of the present application. In conjunction with the accompanying drawings, a detailed description will be given of the specific structure of an embodiment of the battery pack 10 for the vehicle 1 in this application.

FIG. 12 shows a schematic diagram of the three-dimensional structure of the battery pack 10 in one embodiment of the present application. As shown in FIG. 12, the battery pack 10 in this embodiment comprises a housing 100 and a battery 200, a mounting portion 132 is provided on the upper surface of the housing 100, and the battery 200 is mounted and fixed on the mounting portion 132. Among them, the battery 200 comprises 14 battery modules 210, and each battery module 210 comprises 8 battery cells 211. As shown in FIG. 12, according to the size of the mounting space provided by the mounting portion 132, the battery modules 210 are arranged in a 7×2 manner, i.e., 7 rows are provided in the front-back direction of the housing 100, and 2 columns are provided in the left-right direction of the housing 100. The battery cells 211 are rectangular in shape, and the length direction of the battery cells 211 is the same as the front-back direction of the housing 100. Eight battery cells 211 are arranged in parallel in the left-right directions of the housing 100.

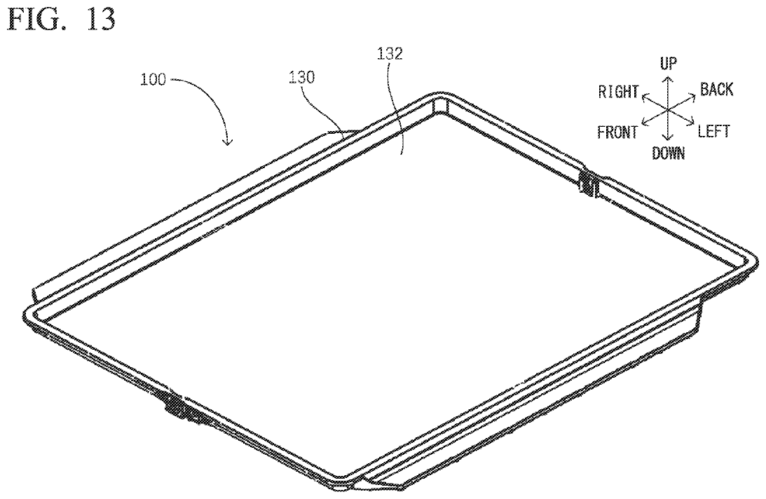

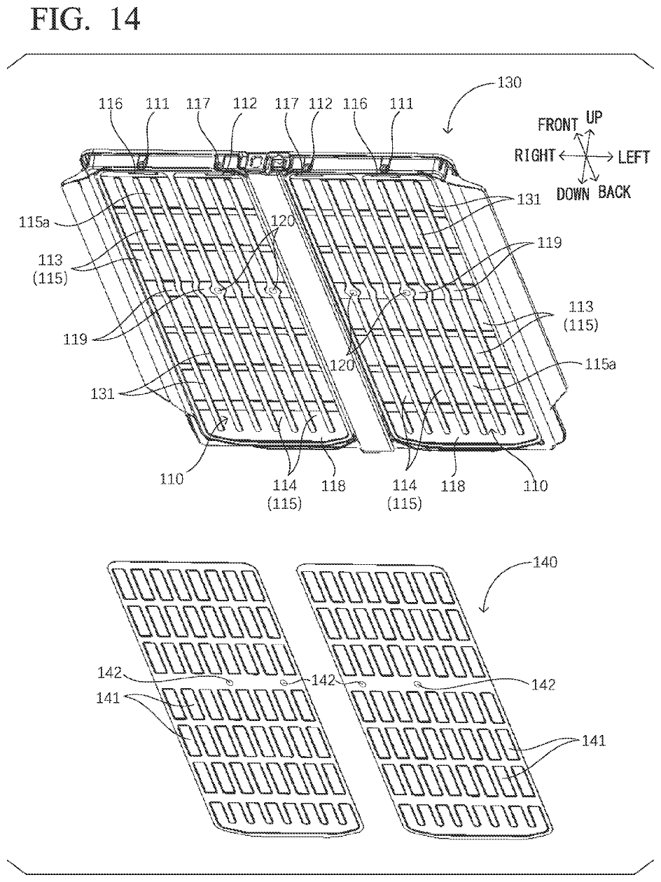

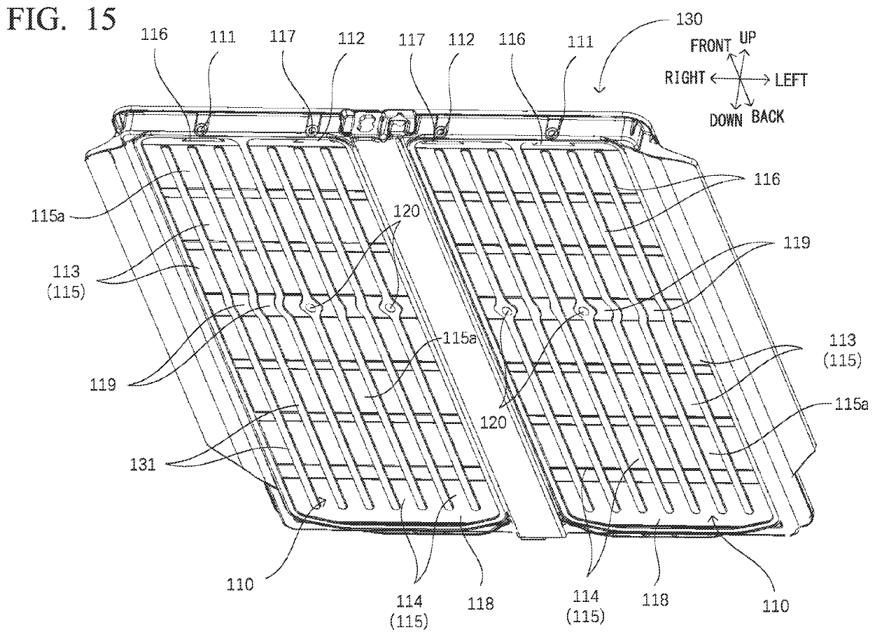

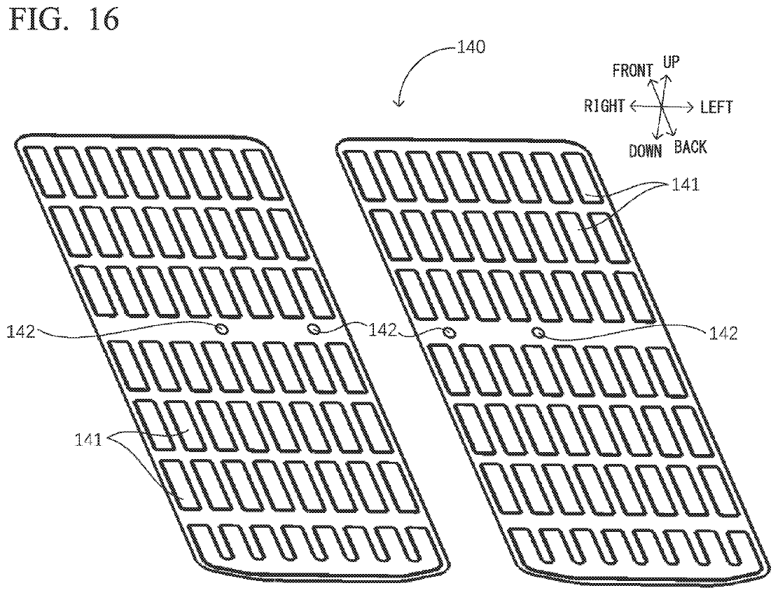

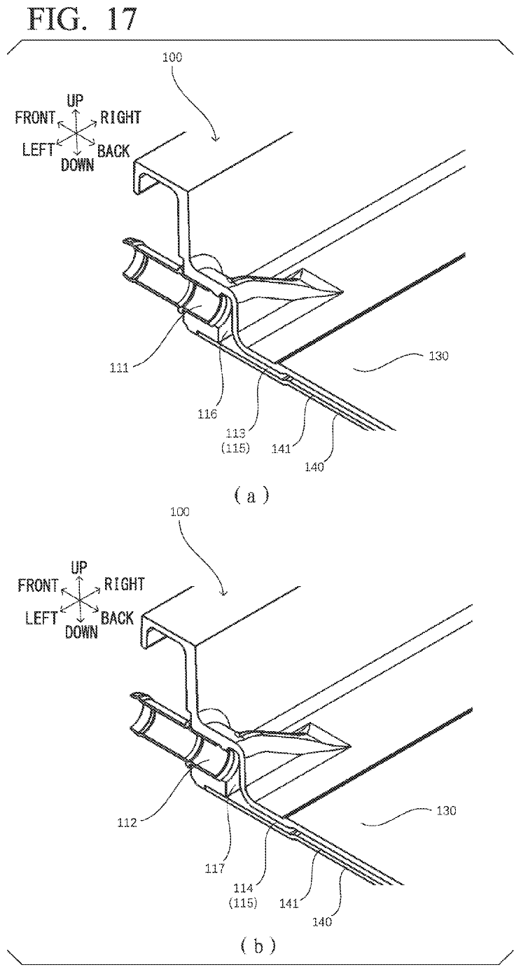

FIG. 13 is a schematic diagram of the structure of the housing 100 in FIG. 12; FIG. 14 is an exploded schematic diagram of the housing 100 in FIG. 12; FIG. 15 is a schematic diagram of the structure of the lower housing 130 in FIG. 14; and FIG. 16 is a schematic diagram of the structure of the base plate 140 in FIG. 14. As shown in FIGS. 12 and 13, the housing 100 is a rectangular shell-like component. The housing 100 may be, for example, mounted on the bottom of the vehicle 1 or may be mounted at another suitable location on the vehicle 1, without limitation.

As shown in FIGS. 12 to 16, the housing 100 in this application embodiment comprises a lower housing 130 and a base plate 140. Among them, the mounting section 132 is tray-shaped and is provided on the upper surface of the lower housing 130. The battery 200 can be set on the mounting portion 132 as shown in FIG. 12, and then the housing 100 is mounted on the vehicle 1, thereby enclosing the battery 200 in the vehicle 1 to provide effective protection for the battery 200. Alternatively, the housing 100 may also include an upper housing (not shown) that may be securely mounted on the upper portion of the lower housing 130, enclosing the battery 200 between the upper housing and the lower housing 130, thereby providing effective protection for the battery 200. A heat transfer adhesive may also be applied between the battery 200 and the lower housing 130, thereby improving the thermal conductivity between the battery 200 and the lower housing 130.

As shown in FIGS. 14 to 16, the base plate 140 is mounted on the lower surface of the lower housing 130, and heat exchanger flow channels 110 are formed between the base plate 140 and the lower housing 130. Two heat exchanger flow channels 110 are provided side by side along the width 30 of the lower housing 130. The heat exchanger flow channels 110 comprise a first flow section 113 and a second flow section 114, the first flow section 113 and the second flow section 114 extend along the length of the lower housing 130 in parallel, and the first flow section 113 is farther from the center of the battery 200 than the second flow section 114. The first flow section 113, the second flow section 114 and the flow chamber 118 are in a U-shaped structure. The lower housing 130 is also provided with a heat exchanger inlet 111 and a heat exchanger outlet 112, with the heat exchanger inlet 111 being farther from the center of the battery cells 200 than the heat exchanger outlet 112. One end of the first flow section 113 is connected to the heat exchanger inlet 111, one end of the second flow section 114 is connected to the heat exchanger outlet 112, and the other ends of the first flow section 113 and the second flow section 114 are connected through the flow chamber 118.

As a result, the heat exchanger can enter the first flow section 113 from the heat exchanger inlet 111, then flow through the second flow section 114, and finally be discharged from the heat exchanger outlet 112. Since the heat exchanger inlet 111 is farther from the center of the battery cells 200 than the heat exchanger outlet 112, the first flow section 113 is farther from the center of the battery cells 200 than the second flow section 114. As a result, the heat exchanger can first exchange heat with the outer part of battery 200 that is greatly affected by environmental temperature, and then exchange heat with the middle part of battery 200 that is less affected by environmental temperature. Thereby, the temperature difference between the different locations of the battery 200 can be reduced and the temperature regulation effect can be improved.

As shown in FIG. 14 and FIG. 15, the lower surface of the lower housing 130 is provided with a plurality of raised convex bars 131 in parallel, which divide the first flow section 113 and the second flow section 114 into four branched paths 115 arranged in parallel. Specifically, the convex bars 131 are provided along the length of the battery cells 211, and after the base plate 140 is mounted on the lower housing 130, the convex bars 131 are set against the base plate 140, dividing each of the first flow section 113 and the second flow section 114 into four branched paths 115 arranged in parallel. The branched paths 115 extend along the length of the battery cells 211, and a branched path 115 is provided under each battery cell 211. The branched paths 115 are not connected in the middle position, but the branched paths 115 in the first flow section 113 and the branched paths 115 in the second flow section 114 are respectively connected at both ends of the first flow section 113 and the second flow section 114. Thus, each branched path 115 can be set to correspond to a battery cell 211 of the battery 200, enabling precise temperature regulation of the battery cells 211. At the same time, it can also reduce the amount of heat exchanger between adjacent battery cells without temperature regulation requirements, thereby reducing the amount of heat exchanger flowing into the heat exchanger channels 110.

As shown in FIGS. 14 and 15, the other ends of the first flow section 113 and the second flow section 114 are connected to the flow chamber 118 which is provided in an arc shape. As a result, the heat exchanger in the flow chamber 118 can be guided, thus reducing the pressure loss of the heat exchanger in the flow chamber 118. It is also possible to prevent the heat exchanger from being sludged in the flow chamber 118, thus improving the efficiency of the heat exchanger.

Further, as shown in FIG. 14 and FIG. 15, the flow chamber 118 is specifically provided with an inferiorly curved shape to reduce the space occupied by the flow chamber 118, making the structure of the housing 100 more compact.

As shown in FIGS. 14 and 15, the widths of branched paths 115 are the same, so that the pressure loss of the heat exchanger between different branched paths 115 can be made more uniform, and the pressure loss between them is more uniform to avoid increasing the pressure loss of the heat exchanger channel 110 due to excessive pressure loss of a certain branched path 115. At the same time, setting the widths between the branched paths 115 to be the same can also make the flow rate of the heat exchanger in each branched path 115 more uniform, which will lead to a more uniform rate of temperature regulation of the battery 200 and improve the temperature regulation effect.

Further, when the battery cells 211 are laid out, two adjacent battery cells 211 are usually set close to each other in order to be able to reduce the size and use the installation space more effectively. In addition, since the convex bars 131 also need to occupy a certain amount of space, the width of the branched paths 115 can be set smaller than the width of the battery cells 211 as shown in FIGS. 14 and 15.

Further, the smaller the width of the branched paths 115, the smaller the area in which the battery cells 211 and the branched paths 115 overlap in the vertical direction. Accordingly, this lowers the thermal conductivity between the battery cells 211 and the branched paths 115. Therefore, in order to ensure the efficiency of heat exchange between the battery cells 211 and the branched paths 115, the width of the branched paths 115 can be set to be greater than half of the width of the battery cells 211 as shown in FIG. 14 and FIG. 15.

As shown in FIG. 14, FIG. 15 and FIG. 16, the lower housing 130 in this application embodiment is also provided with a first mounting position 120, a second mounting position 142 is provided on the base plate 140 at a position corresponding to the first mounting position 120, and the first mounting position 120 and the second mounting position 142 are mounting holes. After the base plate 140 is provided on the lower surface of the lower housing 130, components such as bolts can be used to pass through the first mounting position 120 and the second mounting position 142 to install the base plate 140 and the lower housing 130 on the vehicle body 20.

As shown in FIGS. 14 and 15, the first mounting position 120 is located in the middle of two branched paths 115 (i.e., on a convex bar 131), and is a mounting hole penetrating the lower housing 130. The convex bars 131 form arc-shaped turns at the corresponding positions on the left and right sides of the first mounting position 120, so that branched paths 115 form deflecting bends at the corresponding positions on the left and right sides of the first mounting position 120. Furthermore, the size of the curved turns on the convex bars 131 is set such that a branched path 115 further away from the first mounting position 120 has smaller curvature of the deflecting bend 119. As a result, the widths of the branched paths 115 at the deflecting bends 119 can be made more uniform, and thereby the flow rate of the heat exchanger between the different branched paths 115 can be made more uniform, so as to improve the temperature regulation effect. At the same time, it is also possible to make the width of the branched paths 115 at the deflecting bend 119 not change too much, thus reducing the pressure loss of the heat exchanger in the branched paths 115.

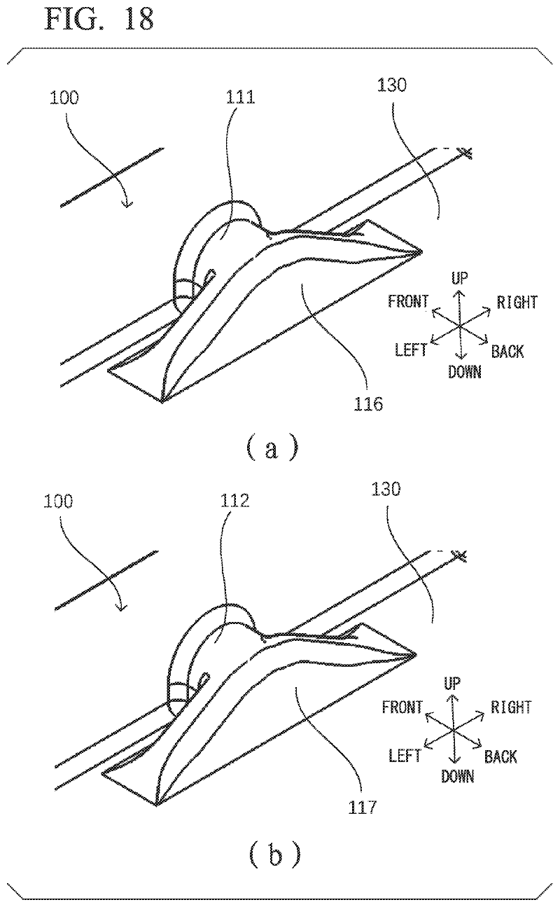

FIG. 17 shows a radial section of the heat exchanger inlet 111 and the heat exchanger outlet 112 in FIG. 13; and FIG. 18 is a partially enlarged schematic diagram of the feeding chamber 116 and the discharging chamber 117 in FIG. 13. As shown in FIG. 15, FIG. 17, and FIG. 18, the feeding chamber 116 is connected between the heat exchanger inlet 111 and the first flow section 113 in this application embodiment, and the discharging chamber 117 is connected between the heat exchanger outlet 112 and the second flow section 114. The heat exchanger inlet 111 and the heat exchanger outlet 112 are located at a higher position than the first flow section 113 and the second flow section 114. Specifically, the lower end of the feeding chamber 116 is connected to one end of the first flow section 113, and the lower end of the discharging chamber 117 is connected to one end of the second flow section 114. The heat exchanger inlet 111 is set horizontally and connected to the feeding chamber 116 at the upper part of the feeding chamber 116, and the heat exchanger outlet 112 is set horizontally and connected to the discharging chamber 117 at the upper part of the discharging chamber 117.

Thus, after the battery pack 10 is installed on the bottom of the vehicle 1, by arranging the heat exchanger inlet 111 and the heat exchanger outlet 112 at a higher position than the first flow section 113 and the second flow section 114, the lower housing 130 can protect the heat exchanger inlet 111 and the heat exchanger outlet 112 from colliding with the objects below the vehicle 1 during the driving of the vehicle 1, and reduce the chance that the heat exchanger inlet 111 and the heat exchanger outlet 112 will leak due to the collision. As a result, protective structures for the heat exchanger inlet 111 and the heat exchanger outlet 112 can be reduced, and the structural strength of the housing 100 can be improved.

As shown in FIGS. 17 and 18, the feeding chamber 116 has an overall trapezoidal-like shape, and the cross-sectional area of the feeding chamber 116 in the horizontal direction gradually increases from top to bottom. Thus, the heat exchanger flowing in the feeding chamber 116 can be guided so that the heat exchanger flows in the feeding chamber 116 towards each branched path 115 in a diffuse manner. As a result, the pressure loss of the heat exchanger in the feeding chamber 116 can be reduced, and the flow of the heat exchanger can be facilitated to improve the effect of temperature regulation.

Further, the area of the horizontal cross section on the feeding chamber 116 that is connected to the heat exchanger inlet 111 is equal to the area of the vertical cross section on the heat exchanger inlet 111, and the area of the horizontal cross section on the discharging chamber 117 that is connected to the heat exchanger outlet 112 is equal to the area of the vertical cross section on the heat exchanger outlet 112. As a result, when the heat exchanger flows through the heat exchanger inlet 111, the heat exchanger outlet 112, the feeding chamber 116, and the discharging chamber 117, the size of the space for the heat exchanger to pass through is kept constant, thus further reducing the pressure loss of the heat exchanger and improving the heat exchange efficiency.

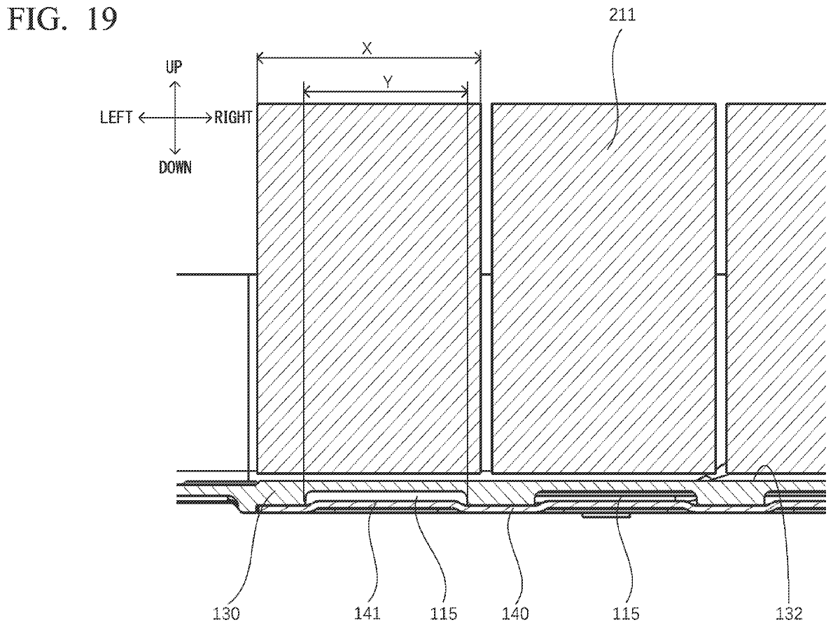

FIG. 19 shows a partial cross-sectional enlarged view of the battery pack 10 in FIG. 12 at the corresponding position of the battery cells 211. As shown in FIGS. 14, FIG. 16 and FIG. 19, the base plate 140 in this application embodiment is provided with upwardly raised bumps 141, which are provided on the side of the base plate 140 toward the lower housing 130 and are located at positions corresponding to the battery cells 211. The width of the bumps 141 is smaller than the width of the branched paths 115, and the bumps 141 are located inside the branched paths 115 after the base plate 140 is mounted on the lower housing 130. The bumps 141 on the base plate 140 may be made by means of sheet metal, so that inner concave shapes are formed on the lower surface of the base plate 140 at the positions corresponding to the bumps 141. Thus, the structural strength of the base plate 140 at the corresponding positions of the battery cells 211 can be improved. At the same time, the thickness and weight of the base plate 140 can be reduced while meeting the strength requirements of the base plate 140, thus reducing the weight of the housing 100 and achieving light weight.

In addition, when the upper surface of the base plate 140 needs to be machined using the milling cutter, only the upper surfaces of the bumps 141 need to be machined. In other words, only the upper surfaces of the bumps 141 need to be machined, i.e., only the positions corresponding to the battery cells 211 needs to be machined, thus reducing the workload of the milling tool and increasing the machining speed.

As shown in FIGS. 14 and 15, concave parts 115a are provided on the branched paths 115, and the concave parts 115a are rectangular in shape and are located at positions corresponding to the upper parts of the bumps 141, forming concave shapes upward. Thus, it is possible to make the thickness of the housing 130 at the positions opposite to the battery cells smaller than the thickness of the other positions of the housing 130, thereby improving the heat exchange efficiency between the battery cells and the heat exchanger in the branched paths 115. In addition, by providing the concave parts 115a, it is also possible to keep the height of the branched paths 115 constant and prevent the height of the branched paths from being affected by the bumps 141. As a result, the pressure loss of the branched paths 115 can be reduced and the heat transfer efficiency of the heat exchanger can be improved.

As shown in FIG. 19, the width direction of the branched paths 115 in this application embodiment is the same as the width direction of the battery cells 211. In the width direction of the battery cells 211, the branched paths 115 can be set in the middle of the battery cells 211, or can be set to the side as shown in FIG. 17. When the width of the battery cells 211 is defined as X and the width of the branched paths 115 is defined as Y, 0.5X≤Y<X.

Thus, by setting the width of the branched paths 115 to be greater than or equal to half of the width of the battery cells 211, a sufficient contact area can be obtained between the branched paths 115 and the battery cells 211, and at the same time, the presence of sufficient heat exchanger in the branched paths 115 can be ensured. Thus, the heat exchanger flow channel 110 can be made to meet the heat exchange power of the battery 200. In addition, by setting the width of the branched paths 115 to be smaller than the width of the battery cells 211, the width of the branched paths 115 can be prevented from being too large and exceeding the width of the battery cells 211, which would prevent some of the heat exchanger in the branched paths 115 from participating in the heat exchange of the battery cells 211. Thus, it is possible to avoid excess weight and waste of the heat exchange power of the heat exchanger flow channel 110, and to achieve light weight.

Alternatively, the width X of the battery cells 211 and the width Y of the branched paths 115 can be set to 0.5X≤Y≤0.6X, thus enabling the battery 200 to be more lightweight while obtaining sufficient heat exchange power.

The above-mentioned battery pack 10 is installed in the vehicle 1, and the chance of leakage due to collision can be reduced by setting the heat exchanger inlet 111 and the heat exchanger outlet 112 above the first flow section 113 and the second flow section 114, so that collision of the heat exchanger inlet 111 and the heat exchanger outlet 112 and the parts such as the pipes connected thereto with objects appearing below the housing 100 can be avoided. As a result, protective structures set for the heat exchanger inlet 111 and the heat exchanger outlet 112 can be reduced and the structural strength of the housing 100 can be improved.

In addition, since the heat exchanger inlet 111 and the heat exchanger outlet 112 are located above the first flow section 113 and the second flow section 114, the heat exchanger flows up and down in the feeding chamber 116 and the discharging chamber 117. Thus, the horizontal cross-sectional areas of the feeding chamber 116 and the discharging chamber 117 are the cross-sectional areas of the heat exchanger flowing in the feeding chamber 116 and the discharging chamber 117. The cross-sectional areas of the heat exchanger inlet 111 and the heat exchanger outlet 112 are the cross-sectional areas of the heat exchanger flowing in the heat exchanger inlet 111 and the heat exchanger outlet 112. By setting the vertical cross-sectional area of the heat exchanger inlet 111 to 0.5 times to 1.2 times the horizontal cross-sectional area of the feeding chamber 116, and by setting the cross-sectional area of the heat exchanger outlet 112 to 0.5 times to 1.2 times the horizontal cross-sectional area of the discharging chamber 116, the space for the heat exchanger to pass through does not change much when the heat exchanger flows through the heat exchanger inlet 111, the heat exchanger outlet 112, the feeding chamber 116 and the discharging chamber 117, thus reducing the pressure loss of the heat exchanger and avoiding the sudden change of the flow rate of the heat exchanger, which improves the heat exchange efficiency. At the same time, it is possible to prevent the heat exchanger inlet 111 or the heat exchanger outlet 112 from being too large, which would increase the amount of the heat exchanger, thus making the vehicle 1 lightweight.

After the battery pack 10 is set on the vehicle body 20, the first flow section 113, the second flow section 114 and the branched paths 115 of the battery pack 10 are connected along the vehicle 1.

Based on this, for example, when the length direction of the battery cells 211 in the battery pack 10 is in the same direction as the length direction of the vehicle 1, it is possible to make the first flow section 113 and the second flow section 114 extend in the same direction as the length direction of the battery cells 211. Since the length dimension of the battery cells is greater than the width dimension, under the same contact area with the battery cells 211, when the first flow section 113 and the second flow section 114 extend in the length direction of vehicle 1, compared to when they extending in the width direction of vehicle 1, the length and width of the first flow section 113 and the second flow section 114 at the turning position are smaller. As a result, the capacity of the heat exchanger in the turning position of the first flow section 113 and the second flow section 114 can be reduced, and thus the weight of the battery pack 10 and the vehicle 1 can be reduced to achieve light weight.

In one embodiment of the battery pack 10 of the vehicle 1 of the present application, the battery pack 10 comprises a housing 100 and a battery 200 provided on the housing 100, as can be seen from the above drawings and description.

The battery 200 comprises at least two cells 211 provided side by side, and the length of the battery cells 211 is in the same direction as the length of the vehicle 1.

The housing 100 is provided with heat exchanger flow channels 110 for regulating the temperature of the battery 200, and there are two heat exchanger flow channels 110 provided symmetrically with the center line L as the center. The heat exchanger flow channels 110 comprise a heat exchanger inlet 111 and a heat exchanger outlet 112, and the heat exchanger inlet 111 is farther from the center line L than the heat exchanger outlet 112. The heat exchanger flow channels 110 also comprise a first flow section 113 and a second flow section 114, with the first flow section 113 and the second flow section 114 provided in a straight line. One end of the first flow section 113 is connected to the heat exchanger inlet 111, and one end of the second flow section 114 is connected to the heat exchanger outlet 112. The other ends of the first flow section 113 and the second flow section 114 are connected through the flow chamber 118, and together form a U-shaped structure. The first flow section 113 is farther from the centerline L than the second flow section 114.

Based on this, it is possible to make the heat exchanger enter the first flow section 113 from the heat exchanger inlet 111 and then be able to first come in contact with the outer part of the battery cells 200 which is affected by the environmental temperature. After the heat exchanger flows into the second flow section 114 and then exchanges heat with the middle part of the battery 200, which is less affected by the environmental temperature. Thus, the temperature difference between different positions of the battery 200 can be reduced and the temperature regulation effect can be improved.

The first flow section 113 and the second flow section 114 each comprise at least two branched paths 115, each of which is located on one side of a battery cell 211, wherein the width direction of the branched paths 115 is the same as the width direction of the battery cells 211. When the width of the battery cells 211 is defined as X and the width of the branched paths 115 as Y, it is preferred that the width X of the battery cells 211 and the width Y of the branched paths 115 be set to 0.5X≤Y<X. More preferably, the width X of the battery cells 211 and the width Y of the branched paths 115 can also be set to 0.5X≤Y≤0.6X.

Based on this, by setting the width of the branched paths 115 to be greater than or equal to half of the width of the battery cells 211, the branched paths 115 and the battery cells 211 can obtain a sufficient contact area, and at the same time, it can be ensured that there is sufficient heat exchanger in the branched paths 115, so that they can quickly achieve heat exchange with the battery cells 211. Thus, it can meet the heat exchange power requirement of the battery 200. In addition, by setting the width of the branched paths 115 to be less than the width of the battery cells 211, the width of the branched paths 115 can be prevented from being too large and exceeding the width of the battery cells 211, which would make some of the heat exchanger in the branched paths 115 unable to participate in the heat exchange of the battery cells 211. As a result, it is possible to avoid excess weight and waste of the heat exchange power of the heat exchanger flow channel 110 and achieve light weight.

The heat exchanger inlet 111 and the heat exchanger outlet 112 are located above the first flow section 113 and the second flow section 114 in order to avoid collisions between the heat exchanger inlet 111, the heat exchanger outlet 112, and the connected pipes thereto and other components with objects below the battery pack, and to reduce the rate of liquid leakage caused by collisions.

The heat exchanger inlet 111 and the heat exchanger outlet 112 are set in the horizontal direction in the form of a circular tube, and the feeding chamber 116 and the discharging chamber 117 are in the form of a trapezoid. The cross-sectional area of the feeding chamber 116 in the horizontal direction is gradually increased from top to bottom, and the cross-sectional area of the discharging chamber 117 in the horizontal direction is gradually decreased from bottom to top. The horizontal cross-sectional area of the feeding chamber 116 at the axial position of the heat exchanger inlet 111 is equal to the vertical cross-sectional area of the heat exchanger inlet 111 perpendicular to the axis. The horizontal cross-sectional area of the discharging chamber 117 at the axial position of the heat exchanger outlet 112 is equal to the vertical cross-sectional area of the heat exchanger outlet 112 perpendicular to the axial center. As a result, when the heat exchanger flows through the heat exchanger inlet 111, the heat exchanger outlet 112, the feeding chamber 116, and the discharging chamber 117, the size of the space for the heat exchanger to pass through remains the same, thus further reducing the pressure loss of the heat exchanger and improving the heat transfer efficiency.

Note that the foregoing is only a preferred embodiment of the present application and the technical principles employed. It will be understood by those of skill in the art that the present invention is not limited to the particular embodiments described herein, but is capable of various obvious variations, readjustments, and substitutions without departing from the scope of protection of the present invention. Therefore, although the present application has been described in some detail through the above embodiments, the present invention is not limited to the above embodiments, but may include more other equivalent embodiments without departing from the conception of the present invention, all of which fall within the scope of protection of the present invention.

What is claimed is:

1. A battery pack comprising a housing and a battery arranged on said housing,
wherein a heat exchanger flow channel is provided on said housing for regulating the temperature of the battery, and said heat exchanger flow channel comprises a heat exchanger inlet, a heat exchanger outlet, and at least one flow section connecting said heat exchanger inlet and said heat exchanger outlet;
said heat exchanger inlet and said heat exchanger outlet are located higher than said flow section;
said flow section is connected to said heat exchanger inlet through a feeding chamber, and when the horizontal cross-sectional area of said feeding chamber at a position connected to said heat exchanger inlet is defined as A and the cross-sectional area of said heat exchanger inlet is defined as B, 0.5A≤B≤1.2A;
and/or said flow section is connected to said heat exchanger outlet through a discharging chamber, and when the horizontal cross-sectional area of said discharging chamber at a position connected to said heat exchanger outlet is defined as C and the cross- sectional area of said heat exchanger outlet is defined as D, 0.5C≤D≤1.2C.

2. The battery pack according to claim 1,
wherein the horizontal cross-sectional area A of said feeding chamber and the cross-sectional area B of said heat exchanger inlet are set as A=B;
and/or the horizontal cross-sectional area C of said discharging chamber and the cross-sectional area D of said heat exchanger outlet are set as C=D.

3. The battery pack according to claim 1,
wherein the horizontal cross-sectional area of said feeding chamber gradually increases from top to bottom;
and/or the horizontal cross-sectional area of said discharging chamber gradually decreases from bottom to top.

4. The battery pack according to claim 1, wherein said heat exchanger flow channel includes two flow sections;
the heat exchanger flow channel further comprises a flow chamber;
the cross-sectional shape of said flow chamber on the side far from the flow section in the horizontal direction is inferiorly curved;
and/or the cross-sectional shape of said flow chamber in the horizontal direction is a trapezoid, the lower edge of said trapezoid is set on the side near said flow section, and the upper edge of the trapezoid is far away from said flow section.

5. The battery pack according to claim 4,
wherein said two flow sections and said flow chamber of said heat exchanger flow channel jointly form a U-shaped structure.

6. The battery pack according to claim 5, wherein the number of said heat exchanger flow channels is more than two.

7. The battery pack according to claim 1, wherein said heat exchanger flow channel extends in the length direction of said housing.

8. The battery pack according to claim 1, wherein said flow section comprises at least two branched paths, which are spaced and arranged in parallel.

9. The battery pack according to claim 8, wherein a mounting position is arranged on said housing, and the mounting position is arranged between said two branched paths, and said branched paths are equipped with a deflecting bend, which is curved to avoid said mounting position.

10. The battery pack according to claim 9, wherein the further away a branched path is from said mounting position, the smaller the curvature of its deflecting bend.

11. The battery pack according to claim 8, wherein the widths of said branched paths are the same.

12. The battery pack according to claim 8, wherein, if the height dimension of said branched paths is defined as h, then 2.1 mm≤h≤3.1 mm.

13. The battery pack according to claim 1, wherein said housing comprises:
a lower housing; and
a base plate installed on said lower housing, with a heat exchanger flow channel formed between said base plate and said lower housing.

14. The battery pack according to claim 13, wherein, said battery comprises at least two battery modules, and said battery modules each comprise at least two battery cells; at least two raised bumps facing said lower housing are arranged on the base plate; and the bumps correspond to the positions of the battery cells one to one.

15. The battery pack according to claim 14, wherein said lower housing is connected to the battery through a heat transfer adhesive.

16. The battery pack according to claim 13, wherein further comprising:
a heat insulation layer provided on a side of said base plate away from said lower housing.

17. A vehicle comprising a vehicle body and a battery pack arranged on said vehicle body, wherein the battery pack is the battery pack according to claim 1.

18. The vehicle according to claim 17, wherein said flow section extends in the length direction of the vehicle.
